(19) United States
(12) Patent Application Publication
(10) Pub. No.: US 2011/0220563 A1
(43) Pub. Date: Sep. 15, 2011

(54) FILTER DEVICE AND FILTER ELEMENT

(76) Inventors: Michael Sakraschinsky, St. Ingbert (DE); Norbert Sann, Riegelsberg (DE)

(21) Appl. No.: 12/998,647

(22) PCT Filed: Nov. 24, 2009
(86) PCT No.: PCT/EP2009/008351

§ 371 Date: May 13, 2011

(30) Foreign Application Priority Data
Nov. 26, 2008 (DE) 10 2008 059 146.7

(51) Int. Cl. B01D 35/14

(52) U.S. Cl. 210/130

(57) ABSTRACT

The invention relates to a filter device. The invention further relates to a filter device comprising a filter element (1), which can be removably accommodated in a sheathing (13) and the filter material (9) of which, through which the fluid to be cleaned can flow, separates a space (3) forming the dirty side during the filtration process from a space forming the clean side, and comprising a bypass valve, the closing body (41) of which, when the pressure difference in the spaces exceeds a limit value range, can be moved counter to the action of a closing spring (21) into an open position that allows the pressure difference to be reduced, is characterized in that the closing body (41) as part of the filter element (1) can be removed from the sheathing (13) while attached to the filter element and can be spatially separated from the closing spring (21) in doing so.

The invention relates to a filter device with a filter element which can be held removably in a sheathing, and whose filter material, through which the fluid which is to be cleaned can flow, separates a space which forms the dirty side in the filtering process from a space which forms the clean side, and with a bypass valve whose closing body can be moved against a closing spring into an open position which enables a reduction of the pressure difference at a pressure difference of the spaces which exceeds a boundary value range. Moreover, the invention relates to a filter element which is designed for use in such a filter device.

Filter devices of this type are readily available on the market in the most varied designs. In view of the very great extent to which these filter devices are used, specifically for filtration of working fluids such as hydraulic fluids, fuels, lubricants, and the like, several demands with respect to construction and operating behavior must be met. In view of the large numbers of items, low production costs are an important aspect, both with respect to production of the filter device and also the filter element which is interchangeably held in it. In spite of the simple construction which is desirable, reliable operation of the bypass valve must be ensured in order to enable damage-free operation. For the large number of used filter elements which must be removed from the respective sheathing of the filter device and which must be replaced by new filter elements, a construction is desirable which, without having to accept losses of operational reliability, enables low production costs of the filter elements and thus economical operation of the respective filter device.

In light of these problems, the object of the invention is to make available a filter device and a filter element for use in the filter device which are characterized in use by high operational reliability in a simple construction which is inexpensive to produce.

This object is attained according to the invention by a filter device which has the features of claim 1 in its entirety, and by a filter element with the features of claim 13.

According to the characterizing part of claim 1, an essential particularity of the filter device consists in that the bypass valve which ensures operational reliability in the filtration process is made such that the closing body as a component of the filter element coherently with the latter can be removed from the sheathing and in doing so can be spatially separated from the closing spring of the valve. As a result of this decoupling of the closing spring of the bypass valve from the closing body and thus the filter element, for any replacement only one partial component of the bypass valve is removed with the filter element for disposal, while the closing spring remains on the device side. This enables not only the simple and economical construction of the filter element, but also has the advantage that the critical component of the bypass valve, specifically the closing body, is replaced at the same time, each time the filter element is changed.

Because the closing spring, as a generally metallic element, remains on the device side, there also arises the further advantageous possibility of making the filter element as a whole able to be incinerated, by the closing body being made free of metal like the other part of the filter element which is to be disposed of after removal. In this way, the entire filter element can be easily disposed of as a whole thermally by incineration in an environmentally safe manner without the need for special handling or dismounting measures; this would require special protective measures and high cost due to the nature of the residues which are present in the used filter element, such as oil-containing or corrosive sludges.

According to one preferred construction, the filter element which defines a longitudinal axis on one end can have an end cap which forms an enclosure for the assigned edge of the filter material and on which the bypass valve is arranged such that when the closing body is in the closed position the inner filter cavity is closed fluid tight by the end cap and when the closing body is in the open position, the passage of fluid through the end cap is enabled. The structural assignment of the components of the bypass valve, aside from the closing spring, to one end cap of the filter element enables a simple and compact construction both of the filter element itself and also the entire device.

Here the arrangement can preferably be made such that the closing body is located on the end cap with a capacity to move in the direction of the longitudinal axis and can be raised against the force of the closing spring off a valve seat which is located on one passage of the end cap. For a filter element through which flow can take place from the inner filter cavity to the outside in a filtering process, the valve seat can be formed by the outer opening edge of the passage which is located in the bottom surface of the end cap, the closing spring as compression spring pressing the closing body against the outer side of the bottom of the end cap which forms the lower termination of the inner filter cavity. The closing body, in this case as a closing surface which interacts with the valve seat, can have a plate on which, from the outside of the filter element, the closing spring designed as a compression spring is supported, which in turn is attached to a housing bottom of the sheathing.

In especially advantageous exemplary embodiments, the arrangement is made such that the closing body has a shaft which projects axially into the inner filter cavity from its closing surface which interacts with the valve seat through the passage of the end cap and the end cap has a projection which projects into the filter cavity and on which the shaft is guided in the movement between the closed position and the open position. This guidance contributes to the operational reliability of the bypass valve.

The interaction of the shaft of the closing body with a projection of the end cap which projects into the filter cavity advantageously enables connecting the closing body, without obstructing its operating movements between the closed position and open position, to the element cap such that the closing body is entrained when the filter element is removed from the sheathing. In this respect, the arrangement can be made such that the shaft extends through a bore of the projection and on its end forms a catch body which, when the filter element is removed from the sheathing, locks the closing body in interaction with the edge of the bore of the projection on the latter and thus on the filter element.

In advantageous exemplary embodiments, the sheathing is a hollow body of revolution from whose upper end the filter element can be removed and which is made as a fluid-permeable support pipe which surrounds the outer side of the filter material of the filter element through which flow takes place in the filtering process from the inner filter cavity which forms the dirty side to the outside.

In these exemplary embodiments, the support pipe is preferably made of metal, especially steel, so that the support pipe constitutes a housing element which forms a pressure support for the filter element which is removably held in it.

In these exemplary embodiments, the end cap, which is provided with the bypass valve, can be assigned to the lower end of the support pipe, the closing spring being located on the lower end of the support pipe such that the closing body is released from the closing spring which remains in the support pipe when the filter element is removed from the upper end of the support pipe.

In arrangement of the bypass valve on that end cap which forms the lower termination of the inner filter cavity, dirt which has formed in the filter element in the filtering process can sink down in the filter element when there is no flow through the filter element, for example, when the system is shut down. To prevent a larger amount of settled dirt from collecting in the region of the passage of the end cap, the arrangement can preferably be made such that the projection of the end cap exhibits a protective plate which forms a dirt trap, which overlaps the region of the passage, and which contains the bore for the shaft of the closing body.

For especially advantageous exemplary embodiments, a washer is slipped onto the shaft of the closing body such that it is located on the longitudinal section of the shaft which is located within the projection of the end cap at an axial distance from the closing surface of the closing body which interacts with the valve seat and it adjoins the inner edge of the passage and closes it when the filter element is removed and thus in the absence of force of the closing spring and for a displacement motion of the closing body which is produced by gravity. This results in that when the closing body is in the open position, if therefore when the filter element is removed, the closing force of the closing spring is not active, the opening of the passage is closed by the washer which has been slipped onto the shaft so that dirt which has not collected on the protective plate cannot escape via the passage.

For the use of the filter device as a pressure filter, the sheathing can be formed by a filter housing in which the filter element can be held for throughflow from the outside to the inside, the bypass valve being provided on the end cap of the filter element which is assigned to the upper end of the filter housing which can be closed by the housing cover, and the closing spring being attached to the housing cover such that it applies the closing force to the closing body when the cover is closed and is released when the housing cover is removed from the closing body of the bypass valve which is located on the filter element which is to be removed.

The subject matter of the invention is also a filter element which is designed for use in a filter device according to the invention and which has the features of claim 13.

The invention is detailed below using the exemplary embodiments shown in the drawings.

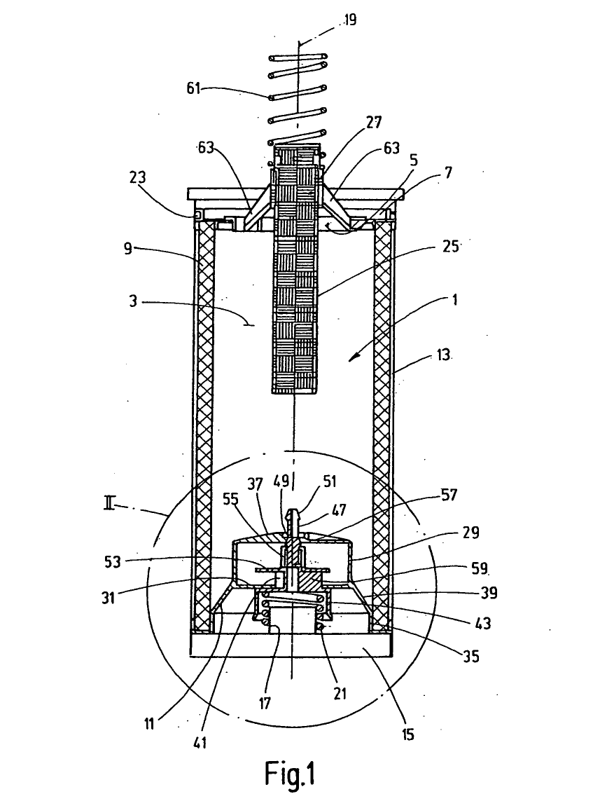

FIG. 1 is a longitudinal section of the main components of one exemplary embodiment of the filter device, of which only one sheathing which is used as outer support pipe is shown, in which a removable filter element is shown in its operating position which is located within the sheathing;

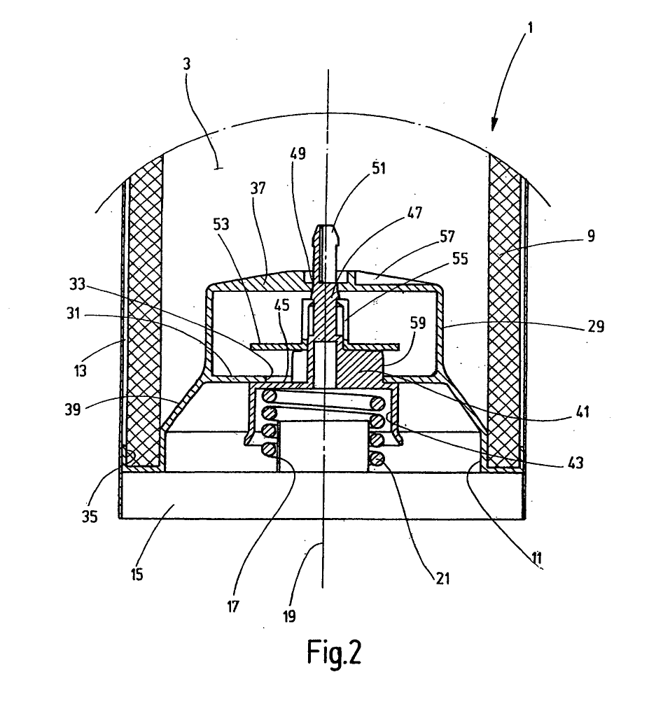

FIG. 2 is a partial extract of the zone designated as II in FIG. 1 on a larger scale than FIG. 1;

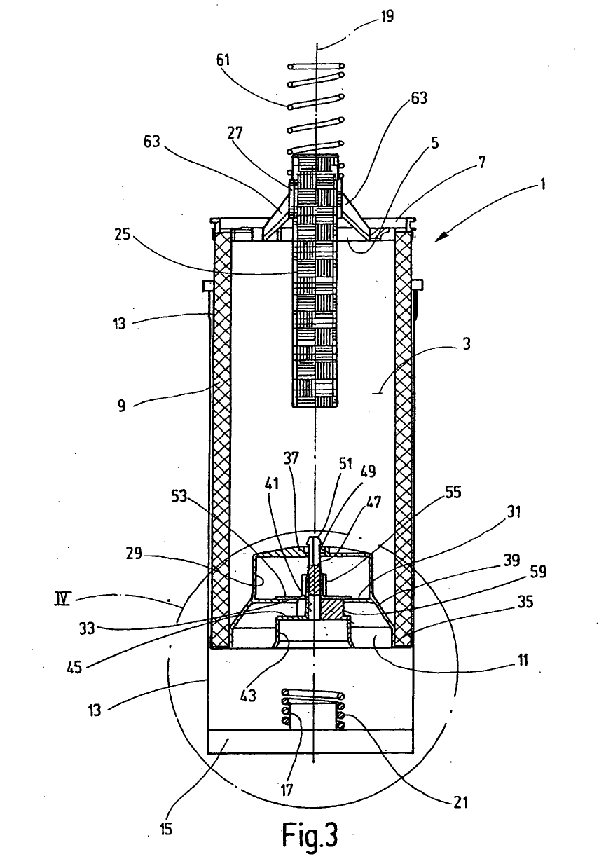

FIG. 3 is a longitudinal section which corresponds to FIG. 1, but the filter element being shown not in its operating position, but removed in part from the sheathing;

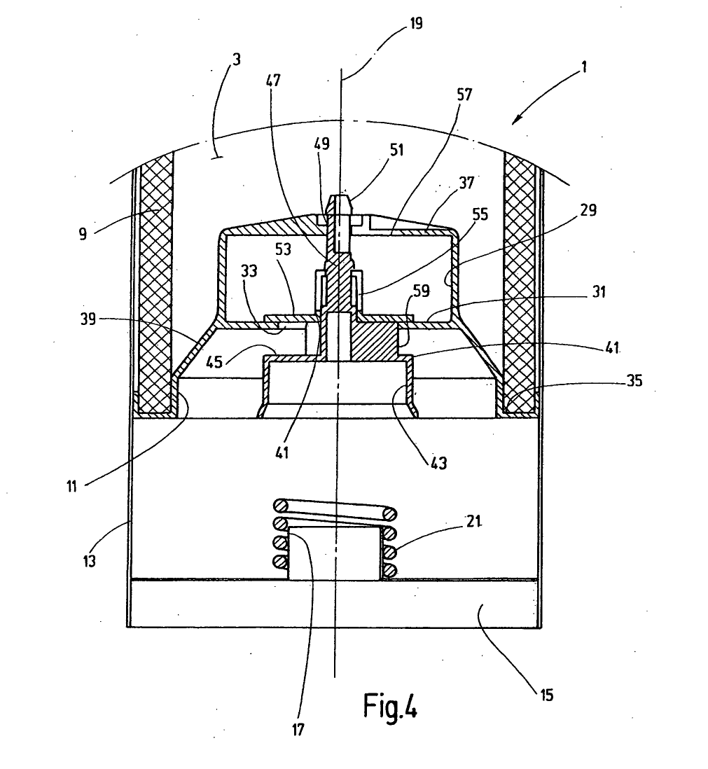

FIG. 4 is a partial extract of the zone designated as IV in FIG. 3, enlarged compared to FIG. 3;

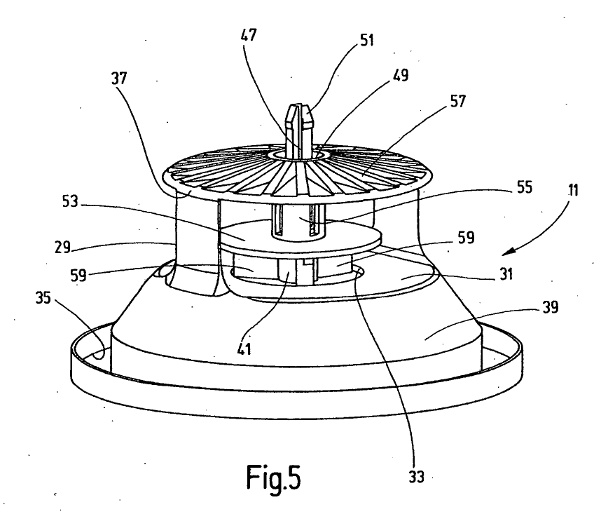

FIG. 5 is a perspective oblique view of only one end cap of the filter element of the exemplary embodiment, shown slightly enlarged relative to FIGS. 2 to 4, with the assigned bypass valve which is shown in the closed position;

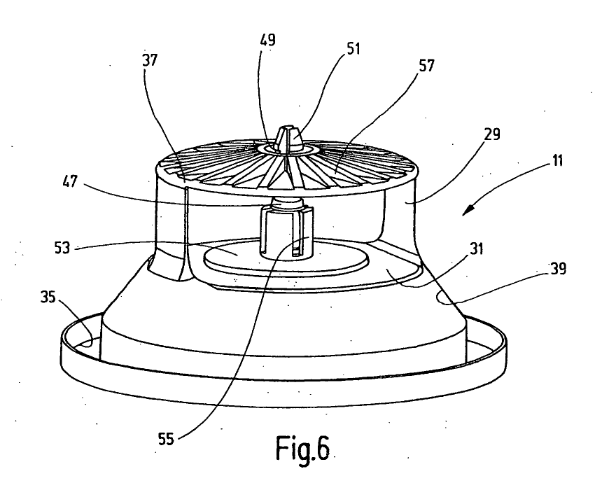

FIG. 6 is a perspective oblique view which corresponds to FIG. 5, the bypass valve being shown in the open position;

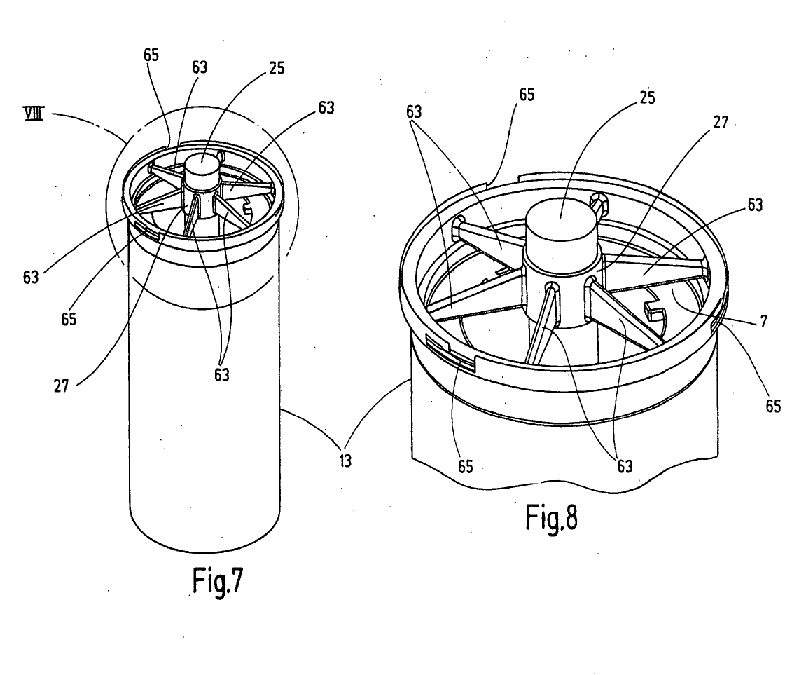

FIG. 7 is a perspective oblique view of the sheathing of the exemplary embodiment with the filter element held in it in the operating position;

FIG. 8 is a partial representation of the zone designated as VIII in FIG. 7, enlarged compared to FIG. 7;

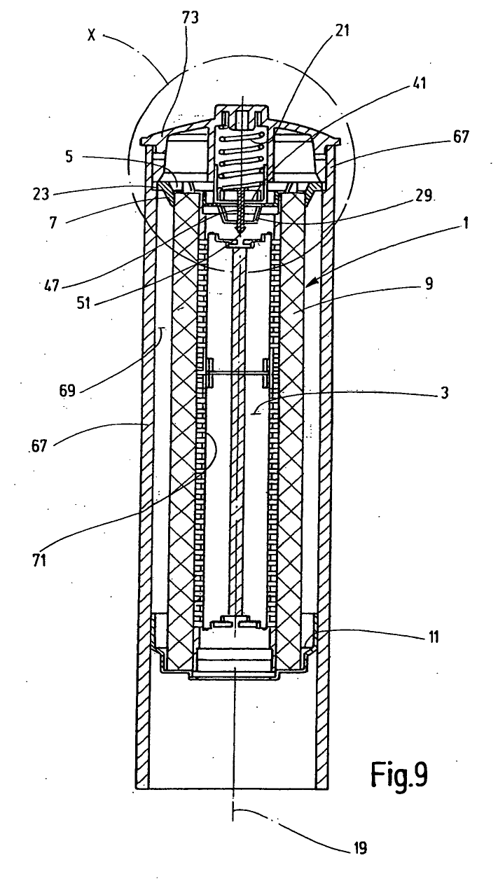

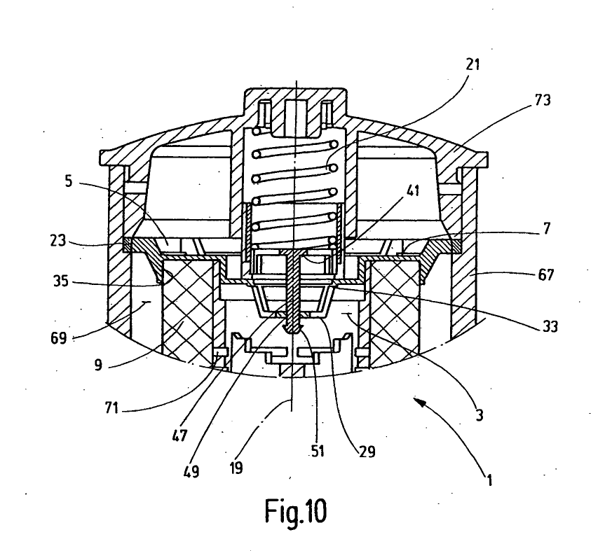

FIG. 9 is a longitudinal section of a modified exemplary embodiment of the device according to the invention in the form of a pressure filter; and

FIG. 10 is a partial extract of the zone designated as X in FIG. 9 on a larger scale than FIG. 9.

The invention is explained based on FIGS. 1 to 8 on the example of a return line filter in which in the filtering process flow takes place through a pertinent filter element 1 from the inside to the outside. The fluid which is to be cleaned is supplied to the inner filter cavity 3 via fluid passages 5 which are located in an upper end cap 7 via fluid guides which are made conventionally in an upper cover (not shown) of a filter housing which is not shown, in which the arrangement shown in FIG. 1 is housed. In operation, the fluid to be cleaned can flow through the filter material 9 which surrounds the filter cavity 3 from the inner filter cavity 3 which forms the dirty side in the filtering process; the filter material is made metal free in the form of a mat structure in this exemplary embodiment. The filter element 1 with the upper end cap 5 which is molded from plastic and which forms the upper enclosure of the filter material 9, and with the lower end cap 11 which is located on the lower end and which likewise encloses the assigned edge of the filter material 9, is removably held in a sheathing which is a fluid-permeable support pipe 13 of steel in the illustrated exemplary embodiment. In the operating position of the filter element 1 shown in FIGS. 1 and 2, in the support pipe 13 the lower end cap 11 is in contact with the bottom part 15 of the support pipe 13. Concentrically to the longitudinal axis 19, a mandrel body 17 is attached to the bottom part 15 and forms the closing spring 21 of a bypass valve. The lower end cap 11 is molded in one piece from plastic like the upper end cap 7.

In the operating position show in FIGS. 1 and 2, the upper end cap 7 is sealed by means of a peripheral O-ring seal 23 on the support pipe 13 which forms the sheathing. The upper end cap 7 moreover forms the carrier for a magnet insert 25 which is conventionally composed of component magnets and which is held in an aluminum die-cast housing 27 which is removably supported on the upper end cap 7. After removing the filter element 1 from the sheathing formed by the support pipe 13, the die-cast housing 27 is removed from the end cap 5 and is re-used in conjunction with the filter element which is to be newly inserted.

In the operating position of the filter element 1 shown in FIGS. 1 and 2, the force of the tensioned closing spring 21 acts as a pretensioning force which closes the bypass valve. As is best illustrated in FIG. 2, the end cap 11 has a projection 29 which is molded in one piece from plastic with the end cap 11, which is concentric to the axis 19, which projection extends axially into the interior of the filter cavity 3 and, aside from the closing spring 21, contains the other components of the bypass valve. The projection 29 forms a flat, central, inner bottom 31 with an inner fluid passage 33 which is concentric to the axis 19. The bottom 31 is located approximately at half height between the end-side enclosure 35 for the filter material 9 and an upper protective plate 37 which forms the upper end of the projection 29 within the inner filter cavity 3. Between the lower enclosure 35 and the bottom 31 of the projection 29, the outside contour of the projection 29 runs with an oblique surface 39 which acts, as explained below, as a dirt trap, and the upper protective plate 37 performs a similar function in this respect, as is likewise explained later. Between the bottom 31 and protective plate 37, a free space is formed in which those parts of a closing body 41 of the bypass valve which extend through the passage 33 are located. The closing body 41 is a one-piece part molded from plastic whose part located outside the passage 33 forms a cup-like spring housing 43 into which the closing spring 21 extends and is supported on the cup bottom of the spring housing 43. In this way, the circular ring-shaped closing surface 45 of the closing body 41 is pressed against the opening edge of the passage 33, which acts as a valve seat. From the closing surface 45 of the closing body 41, a shaft 47 extends through the passage 33 and passes through a central bore 49 in the protective plate 37. On the free end, the shaft 47 forms a catch body 51 which can be pushed through the bore 49, but forms a latch against pulling out of the bore 49. When the filter element 1 is removed from the support pipe 13, therefore the closing body 41 is entrained by the catch body 51 striking the edge of the bore 49, as is shown in FIG. 6. FIGS. 3 and 4 show this state. As FIG. 3 and especially FIG. 4 clearly show, when the filter element 1 is removed from the support pipe 13, the closing body 41 is released from the closing spring 21 which is located on the bottom part 15, while the closing body 41, which is locked on the bore 49 by the catch body 51, is removed with the filter element 1.

FIGS. 3 and 4 show the bypass valve in the open position in which the closing surface 45 of the closing body 41 is located at a distance from the passage 33. Nevertheless, the passage 33 is safeguarded against an escape of dirt from the filter cavity 3. For this purpose, an annular disk-shaped plastic plate 53 is slipped onto the section of the shaft 47 which in the open position of the bypass valve is located between the bottom 31 and the protective plate 37 of the projection, and the plate is fixed with a clamp sleeve 55 on the shaft 47. The plate 53 here rests on the top of vanes 59 which extend radially from the shaft 47 and extend through the passage 33. For the unloaded closing body 41, the force of gravity moves the closing body 41 down so that the plate 53 overlaps the edge of the passage 33. The use of an additional plate 53 is not mandatory. When the plate 53 is omitted, the closing body 41 is lifted out by interaction of the catch body 51 with the bore 49 when the filter element is removed.

The additional plate 53 can be omitted especially in applications in which the action of the protective plate 37, although it has star-shaped interruptions 57 for the fluid passage, acts to repel dirt to a certain extent. In addition, the lateral oblique surface 39 on the projection 29 together with the adjacent inner wall of the filter material 9 forms a “dirt trap basket” which prevents the dirt which has collected in the filter element 1 from reaching the clean side when the element is changed or the bypass valve is opened.

For a filter element 1 which is in the operating position within a filter housing and which is not shown (FIGS. 1 and 2), the lower end cap 11 is held in contact with the lower bottom part 15 of the support pipe 13, which is used as an element receiver, by means of a compression spring 61 which is supported on the one hand on the magnet housing 27 of the magnet insert 25 and on the other hand on the cover of the filter housing, neither of which is shown. Here the spring force of the compression spring 61 acting in the operating state is greater than the action of the force of the closing spring 21 of the bypass valve. To prevent the filter element 1 from being forced out of the support pipe 13 by the action of the closing spring 21 with the housing cover removed (not shown) and thus the compression spring 61 relieved, the pretensioning on the O-ring 23 is chosen such that the closing spring 21 does not press the filter element 1 out of the support pipe 13.

FIGS. 7 and 8 show an additional possibility of safeguarding the filter element 1 against being forced out by the closing spring 21. As is apparent especially from FIG. 8, the magnet housing 27 has star-shaped, radially running arms 63 which on the outside have a collar which, in interaction with bayonet guides 65 on the support pipe 13, forms a quarter-turn catch. When the filter element 1 is replaced, the filter element is thus released when the bayonet lock is released in order to be removed again from the support pipe 13 in which the closing spring 21 of the bypass valve remains. After release of the bayonet lock, the magnet housing 27 is available for re-use in a filter element 1 which is to be newly inserted.

FIGS. 9 and 10 illustrate a second exemplary embodiment in the form of a pressure filter in which the filter element 1 is removably arranged in a filter housing 67 such that, in the filtering process, flow takes place through the filter material 9 from the outside to the inner filter cavity 3. Accordingly, the outer annulus 69 on the outer side of the filter material 9 forms the dirty side, while the inner filter cavity 3 forms the clean side, the filter material 9 surrounding an inner support pipe 71 which is molded from plastic in the conventional manner and peripherally borders the inner filter cavity 3.

For pressure reduction at a pressure difference between the outer annulus 69 and inner filter cavity 3 which exceeds the boundary value range, a bypass valve is assigned to the upper end cap 7 of the filter element 1, and in turn the closing body 41 as a one-piece plastic part is assigned to the end cap 7 and is movably locked on it, while the closing spring 21 is attached to the removable cover 73 of the filter housing 67 so that, when the filter element is replaced, in turn the closing body 41 is separated from the closing spring 21 which remains on the housing cover 73. In turn, as in the first embodiment, the closing body 41 has a shaft 47 with end-side catch body 51 which forms a safeguard of the closing body 41 on a projection 29 of the end cap 7 which, as in the first exemplary embodiment, extends axially into the inner filter cavity 3. As in the first exemplary embodiment, the filter element 1 can thus be formed entirely from materials which can be incinerated, specifically with the plastic closing body 41, plastic end caps 7 and 11, the plastic support pipe 71, and the filter material 9 of a metal-free mat structure.

1. A filter device with a filter element (1) which can be held removably in a sheathing (13, 67), and whose filter material (9), through which the fluid which is to be cleaned can flow, separates a space (3, 6) which forms the dirty side in the filtering process from a space which forms the clean side, and with a bypass valve whose closing body (41) can be moved against a closing spring (21) into an open position which enables a reduction of the pressure difference at a pressure difference of the spaces which exceeds a boundary value range, characterized in that the closing body (41) as a component of the filter element (1) coherently with the latter can be removed from the sheathing (13, 67) and in doing so can be spatially separated from the closing spring (21).

2. The filter device according to claim 1, characterized in that the closing body (41) is made free of metal and able to be incinerated like the other part of the filter element (1) which is to be disposed of after removal.

3. The filter device according to claim 1, characterized in that the filter element (1) which defines a longitudinal axis (19) on one end has an end cap (11, 7) which forms an enclosure (35) for the assigned edge of the filter material (9) and on which the bypass valve is arranged such that when the closing body (41) is in the closed position, the inner filter cavity (3) is closed fluid tight by the end cap (11, 7) and when the closing body (41) is in the open position, the passage of fluid through the end cap (11, 7) is enabled.

4. The filter device according to claim 3, characterized in that the closing body (41) is located on the end cap (11, 7) with a capacity to move in the direction of the longitudinal axis (19) and can be raised against the force of the closing spring (21) off a valve seat which is located on one passage (33) of the end cap (11, 7).

5. The filter device according to claim 4, characterized in that the closing body has a shaft (47) which projects axially into the inner filter cavity (3) from its closing surface (45) which interacts with the valve seat through the passage (33) of the end cap (11, 7) and the end cap (11, 7) has a projection (29) which projects into the filter cavity (3) and on which the shaft (47) is guided in the movement between the closed position and the open position.

6. The filter device according to claim 5, characterized in that the shaft (47) extends through a bore (49) of the projection (29) and on its end forms a catch body (51) which, when the filter element (1) is removed from the sheathing (13, 67), locks the closing body (41) on the edge of the bore (49) on the projection (29) of the end cap (11, 7).

7. The filter device according to claim 1, characterized in that the sheathing is a hollow body of revolution from whose upper end the filter element (1) can be removed and which is made as a fluid-permeable support pipe (13) which surrounds the outer side of the filter material (9) of the filter element (1) through which flow takes place in the filtering process from the inner filter cavity (3) which forms the dirty side to the outside.

8. The filter device according to claim 7, characterized in that the support pipe (13) is made of metal, especially steel.

9. The filter device according to claim 7, characterized in that the end cap (11) which is provided with the bypass valve is assigned to the lower end of the support pipe (13) and that the closing spring (21) is located on the lower end of the support pipe (13) such that the closing body (41) is released from the closing spring (21), which remains in the support pipe (13) when the filter element (1) is removed from the upper end of the support pipe (13).

10. The filter device according to claim 6, characterized in that the projection (29) of the end cap (11) exhibits a protective plate (37) which forms a dirt trap, which overlaps the region of the passage (33), and which contains the bore (49) for the shaft (47) of the closing body (41).

11. The filter device according to claim 5, characterized in that a washer (53) is slipped onto the shaft (47) of the closing body (41) such that it is located on the longitudinal section of the shaft (47) which is located within the projection (29) of the end cap (11) at an axial distance from the closing surface of the closing body which interacts with the valve seat and it adjoins the inner edge of the passage (33) and closes it when the filter element (1) is removed and thus in the absence of force of the closing spring (21) and in a displacement motion of the closing body (41) which is produced by gravity.

12. The filter device according to claim 1, characterized in that for use as a pressure filter, the sheathing is formed by a filter housing (67) in which the filter element (1) can be held for throughflow from the outside to the inside, that the bypass valve is provided on an end cap (7) which is assigned to the upper end of the filter housing (67) which can be closed by the housing cover (73), and that the closing spring (21) is attached to the housing cover (73) such that it applies the closing force to the closing body (41) upon closing and is released when the housing cover (73) is removed from the closing body (41) of the bypass valve located on the filter element (1) which is to be removed.

13. A filter element which is intended for use in a filter device according to claim 1 and which is removably held in a sheathing (13, 67) and as a component of a bypass valve which in the filtration process enables a connection between the dirty side and clean side has a closing body (41) which as a part separated from an assigned closing spring (21) can be removed together with the filter element (1) and like the other part of the filter element (1) which can be disposed of after removal consists of a material which can be incinerated.
